(19) United States
(12) Patent Application Publication
(10) Pub. No.: US 2003/0037450 A1
(43) Pub. Date: Feb. 27, 2003

(54) Layout tool for multiple floor and roof joist in-line through hole drilling

(76) Inventor: James C. Reed, Arroyo Grande, CA (US)

Correspondence Address: James C. Reed, 2315 Callender Road, Arroyo Grande, CA, 93420, US

(21) Appl. No.: 09/940,143

(22) Filed: Aug. 27, 2001

(51) Int. Cl. G01C 15/00

(52) U.S. Cl. 33/286

(57) ABSTRACT

A layout tool for multiple floor and roof joist in-line through drilling (1A) having a laser mounting and vertical adjustment bracket (3) fastened with a pivot pin (10) to a horizontal adjustment bracket (4) with it fastened by a vertical pivot pin (5) to the clamping bracket (6) that has a threaded clamping tube welded to it. The laser mounting and vertical adjustment bracket (3) has two holes to accommodate upper laser (8) and lower laser (9) to be fastened in them. The laser mounting and vertical adjustment bracket (3) has a threaded hole to accommodate the vertical adjustment screw (1). By tuning the vertical adjustment screw left or right it pivots the laser mounting bracket (3) vertically up or down. The horizontal adjustment bracket (4) has a threaded hole to accommodate the horizontal adjustment screw (2). By turning the horizontal adjustment screw (2) left or right it pivots the laser mounting bracket (3) horizontally left or right. The clamp bracket (6) and threaded clamping tube (7) are securely clamped to floor joist (14) with the clamp washer (12) and the clamp nut (13). The spacer block (11) is attached to the clamping bracket (6) to accommodate the shape of the TJI floor joist (14).

### CROSS REFERENCE TO RELATED APPLICATIONS

None submitted

### STATEMENT REGARDING FEDERAL SPONSORED RESEARCH OR DEVELOPMENT

Not Applicable

### REFERENCE TO MICROFICHE APPENDIX

None Submitted

### BACKGROUND OF THE INVENTION

This method and apparatus is the result of the need for an economical and simple labor saving device for the installation of ridge conduits and pipes that pass through multiple floor and/or roof joists in new building construction. These pipes and conduits are for the conveyance of water, waste gas, fire sprinklers and electrical wires. The installation of these pipes and conduits require the drilling of in-line holes to accommodate them. The Layout for these holes is time consuming and difficult especially when gravity fall waste lines require a ¼″ drop per each foot of run. This device will accomplish this by mounting it in the known starting point of the pipe run and setting a target at the end of the known pipe run (as the diagram shows on page 7), if gravity fall is required, than a simple adjustment of the vertical adjustment screw will accomplish the angle needed.

With the use of the aiming laser, on the layout device, mounted at the start of the pipe run it can be adjusted, with the horizontal and vertical adjustment screws, to align with the target at the end of the pipe run. Then the drilling laser is turned on showing with the laser beam where the second joist is to be drilled. Each time the joist is drilled the laser will shine through the drilled hole to show where the next joist is to be drilled until the target is reached or beyond if needed.

The present two methods are to either measure each joist off a perpendicular wall for the horizontal location of the required hole and measure up from the bottom of each joist to locate the vertical position of the required hole. When the holes require a vertical gravity drop for each foot of run this is more difficult and time consuming. Or the other method is to stretch a layout line from the start of the known pipe run to the end of the known pipe run and measured up from the bottom of each joist to locate the vertical position of the required holes. When the holes require a vertical gravity drop for each foot of run this again is more difficult and time consuming.

### BRIEF DESCRIPTION OF THE DRAWINGS

FIG. 1 Is a side view of the layout tool.

FIG. 1A Is a expanded assembly drawing of the layout tool.

FIG. 2 Is a side view showing the layout tool mounted to a TJI floor joist.

FIG. 3 Is a top view showing the layout tool mounted to a TJI floor joist.

FIG. 4 Is a drawing showing how to use the layout tool.

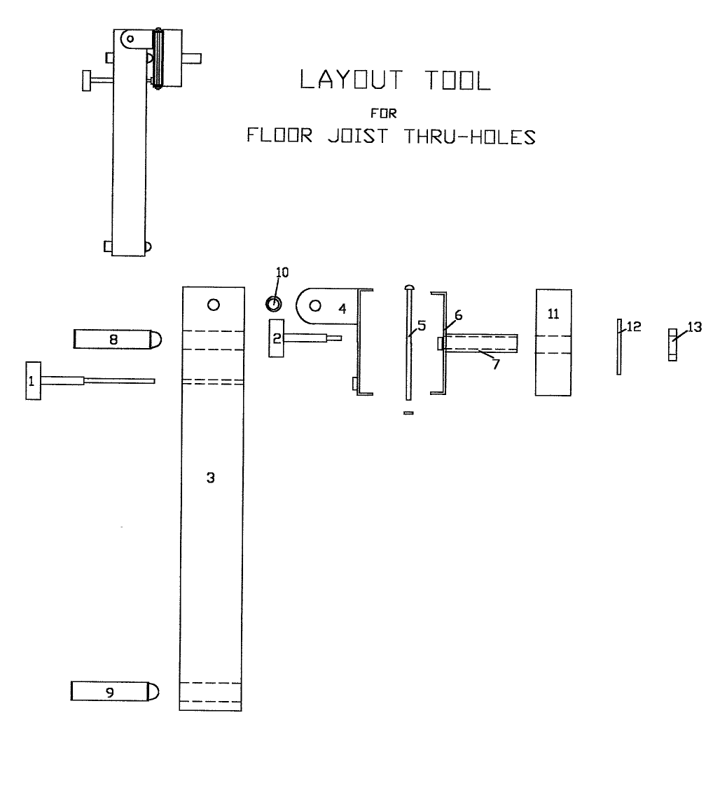

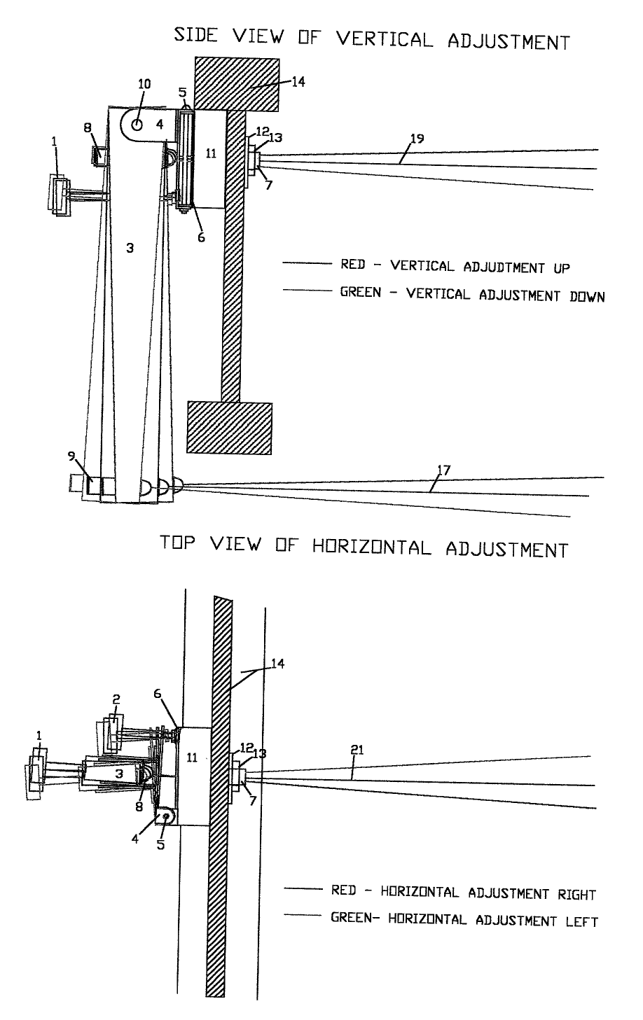

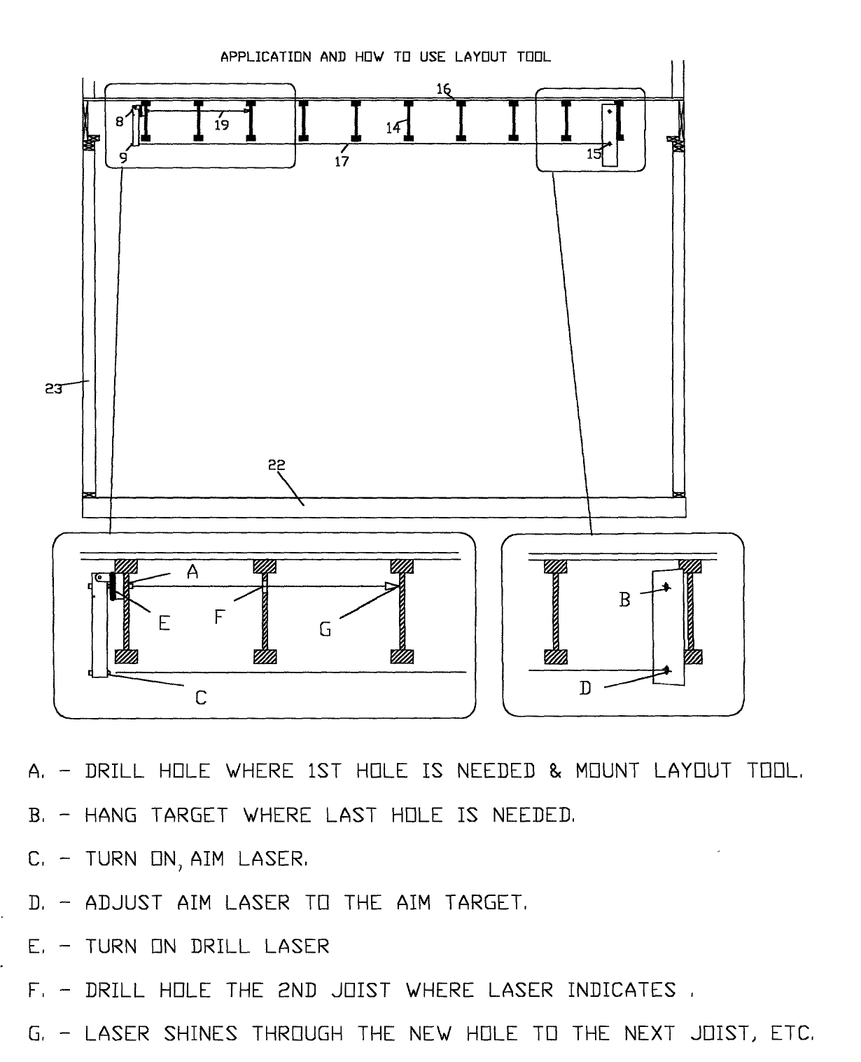

### LIST OF REFERENCE NUMERALS UTILIZED IN THE DRAWINGS

1—Vertical adjusting screw

1A—Layout Tool

2—Horizontal adjusting screw

3—Laser mounting bar/vertical adjustment bracket

4—Horizontal adjustment bracket

5—Horizontal adjustment pivot pin

6—Clamping bracket

7—Threaded clamping tube

8—Upper “where to drill” laser

9—Lower “aiming” laser

10—Vertical pivot pin

11—Spacer block

12—Clamp washer

13—Clamp nut

14—TJI Floor joist

15—Aiming target

16—Sub-flooring

17—Lower aiming laser beam (level)

18—Lower aiming laser beam (¼″ fall to the foot)

19—Upper drill laser beam (level)

1—VERTICAL ADJUSTING SCREW

2—HORIZONTAL ADJUSTING SCREW

3—LASER MOUNT/VERTICAL ADJ. BRACKET

4—HORIZONTAL ADJ. BRACKET

5—HORIZONTAL ADJ PIVOT PIN

6—CLAMPING BRACKET

7—THREADED CLAMPING TUBE

8—DRILL HOLE SPOTTING LASER

9—AIMING LASER

10—VERTICAL PIVOT PIN

11—SPACER BLOCK

12—CLAMP WASHER

13—CLAMP NUT

14—FLOOR JOIST

15—AIMING TARGET

16—SUB-FLOORING

17—AIMING LASER BEAM (LEVEL)

18—AIMING LASER BEAM (¼′ TO THE FOOT FALL)

19—DRILLING LASER BEAM (LEVEL)

20—DRILLING LASER BEAM (¼′ TO THE FOOT FALL)

21—DRILLING LASER BEAM (90 DEGREES TO JOIST)

22—CONCRETE FLOOR

23—2 X WOOD FRAMING

20—Upper drill laser beam (¼″ fall to the foot)

21—Upper drill laser beam (90 degrees to the joist)

22—Concrete floor

23—2 X wood framing

### LIST OF REFERENCE LETTERS UTILIZED IN THE DRAWINGS

A—Drill hole where 1^{st} hole is needed and mount layout tool.

B—Hang target where last hole is needed.

C—Turn on lower aim laser.

D—Adjust lower aim laser to the aim target.

E—Turn on upper drill laser.

F—Drill hole in the joist where the laser beam indicates.

G—Upper drill laser beam now emits through the new hole to the next joist to be drilled, etc. etc.

1. The design and/or use of the Floor and Roof Joist layout apparatus' offset aiming technique to accommodate an assembly of joists.

2. The design and/or use of the Floor and Roof Joist layout apparatus' clamping tube to be used to attach the apparatus to the joist.

3. The design and/or use of the floor and Roof Joist layout apparatus' clamp to be hollow to allow the laser light to pass through it for the hole drilling operation.

4. The design and/or use of the Floor and Roof Joist layout apparatus' hollow clamping tube to use the first hole of the pipe run for mounting the layout apparatus.
